(19) United States
(12) Patent Application Publication
(10) Pub. No.: US 2026/0194648 A1
(43) Pub. Date: Jul. 9, 2026

(54) MONITORING SYSTEM ENHANCED WITH MILLIMETER-WAVE SENSING

(71) Applicant: NOMO International, Inc., Edina, MN (US)

(72) Inventors: Kevin Ray, Oakland, CA (US); Cristian Codreanu, Chicago, IL (US)

(21) Appl. No.: 19/439,240

(22) Filed: Jan. 2, 2026

Related U.S. Application Data
(60) Provisional application No. 63/741,746, filed on Jan. 3, 2025.

(51) Int. Cl. G01S 13/86; G01S 13/04; G06V 10/764; G06V 20/52; G06V 40/10; G06V 40/20

(52) U.S. Cl. CPC G01S 13/867; G01S 13/04; G06V 10/764; G06V 20/52; G06V 40/10; G06V 40/20

(57) ABSTRACT

Methods, devices and systems for monitoring a home or other environments, including detection of activities related to movement of a person within a home environment, are described. An example monitoring system includes a hub device communicably coupled to a plurality of sensor devices deployed in an area and configured to collect sensor data for the area. At least one of the sensor devices includes a millimeter-wave (mmWave) sensing component configured to generate three-dimensional sensor data based on the transmission of mmWave signals, which enables the monitoring system to detect normal and abnormal activities as well as non-activities, within the monitored environment.

### CROSS-REFERENCE TO RELATED APPLICATIONS

This application claims priority to U.S. Provisional Application No. 63/741,746 titled “MONITORING SYSTEM ENHANCED WITH MILLIMETER-WAVE SENSING” filed on Jan. 3, 2025, the contents of which are incorporated herein by reference in their entirety.

### TECHNICAL FIELD

The technology in this patent document relates to methods and devices that operate based on millimeter-wave technology.

### BACKGROUND

Conventional monitoring systems require considerable user intervention and interaction to be reliably set up to monitor human activity in a building and provide a corresponding response for the human activity. However, after being set up to monitor human activity, the process of monitoring human activity in conventional monitoring systems is still prone to false positives and conventional monitoring systems require training and additional information. Therefore, there is a need for improved monitoring systems that can be implemented with lower cost while providing reliable monitoring capabilities.

### BRIEF DESCRIPTION OF THE DRAWINGS

FIG. 1 illustrates an exemplary network environment for implementing a monitoring system.

FIG. 2 illustrates an exemplary monitoring device of a monitoring system, according to some implementations of the present disclosure.

FIG. 3 illustrates an example portion of a monitoring device that implements a mmWave sensing device, according to some implementations of the present disclosure.

FIG. 4 is a flow chart illustrating an exemplary method for implementing mmWave sensing within a monitoring system, according to some implementations of the present disclosure.

FIG. 5 illustrates an example mounting platform for positioning a mmWave sensing device of a monitoring system, according to some implementations of the present disclosure.

FIG. 6 is a flow chart illustrating an exemplary method for implementing onboard machine learning classifiers for a monitoring system, according to some implementations of the present disclosure.

FIG. 7 is a flow chart illustrating an exemplary method for using mmWave sensing data collected by a monitoring system, according to some implementations of the present disclosure

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the scope of the disclosure as defined by the appended claims.

### DETAILED DESCRIPTION

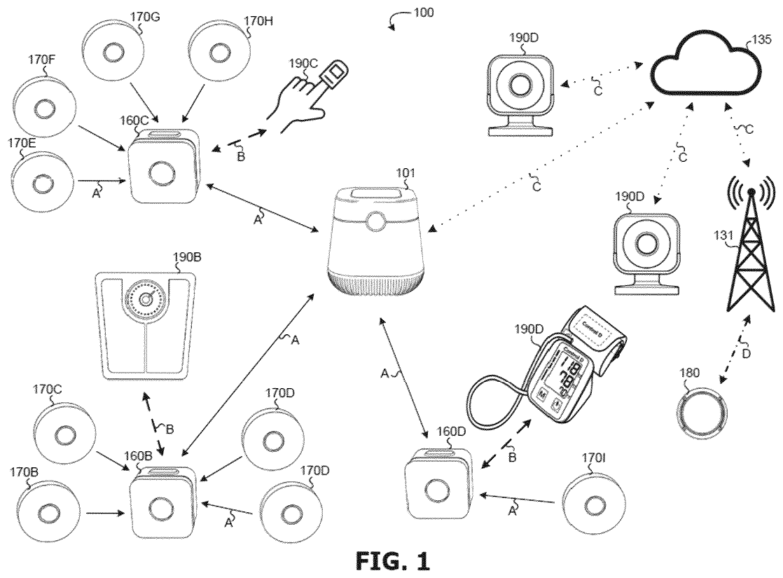

FIG. 1 and the associated description describe example monitoring systems and operations that were described in U.S. patent application Ser. No. 18/172,610 (published as U.S. Patent Publication No. 2023/0263393 A1), assigned to the assignee of the present application, which is incorporated by reference as part of this patent document. The disclosed technology of the present application can be used as part of monitoring system of FIGS. 1-6 and/or as part of other monitoring systems that can benefit from improved detection capabilities and enhancements that are disclosed herein.

In this patent document, the term “exemplary” is used to describe an example or a particular embodiment of the disclosed devices, components systems and/or methods. Specific details of several embodiments of monitoring systems and associated systems and methods are described below.

In this disclosure, numerous specific details are discussed to provide a thorough and enabling description for embodiments of the present disclosure. One of ordinary skill in the art will recognize that the disclosure can be practiced without one or more of the specific details. Well-known structures and/or operations often associated with monitoring devices and monitoring systems may not be shown and/or may not be described in detail to avoid obscuring other aspects of the disclosure. In general, it should be understood that various other devices, systems, and/or methods in addition to those specific embodiments disclosed herein may be within the scope of the present disclosure.

### General Overview and Technical Benefits

Conventional home monitoring systems use one or more smart home devices (e.g., cameras, lights, thermostats, locks, etc.) and smart device accessories (e.g., motion sensors, environmental sensors, and trigger sensors) combined with pre-programmed sounds and detected events to detect and monitor human and pet activity, smoke, fire, air quality and humidity, and to listen for specific sounds such as baby crying or glass breaking. Although, conventional home monitoring systems may be used to monitor all activity in a household and filter through specific activity before notifying a user, for home monitoring systems to be practical and effective, users are often required to network multiple cameras with smart home devices and/or sensors to determine what occurred in the home and are then asked to manually enter a corresponding task, collect data, analyze, and report the activity data to the user. The process of determining an activity and corresponding response is a complicated process and a hassle for typical users. Moreover, user intervention and device training are often required to prevent false positives, for example, filtering out a break-in or suspicious activity alert from events such as drapes blowing or pets moving around the house. To prevent false positives, conventional home monitoring system then need to be trained or setup to monitor for a specific family setup or floorplan by knowing/monitoring the activity of every family member and pet in a household. For example, monitoring for glass break or a break-in, requires a home monitoring system to constantly monitor and know (preferably multiple) user locations, phone locations, personal information, and sensed motion information (preferably audio and/or visual recognition) from all potential entry points to always ensure the safety of family members.

Further, more accurate and costly conventional monitoring systems use sophisticated integration of devices and/or costly hardware that collect, store, retrieve, and compare user's profile, voice, face, or image recognition data that is vulnerable to security hacks, can lead to identity theft, and still requires considerable training and setup to work reliably. Thus, proper setup of monitoring systems to account for pets, drapes blowing, and random human activity and behavior can be very costly, complicated and a hassle for typical users. Further, to be practical and effective in monitoring users and providing peace of mind, monitoring systems require comprehensive surveillance of multiple spaces within a building to account for user variability and human activity, which is often intrusive or costly, puts users at risk to security hacks or identity theft, and/or poses a privacy concern for users who want peace of mind but do not want to their personal information and whereabout collected, stored, and shared.

The conventional monitoring systems may also produce measurements, alerts and, more generally, excess data points that may not convey useful information unless properly aggregated, analyzed and/or interpreted.

Some existing systems and applications utilize millimeter-wave (mmWave) sensing, which utilizes electromagnetic waves in the millimeter-wave spectrum (typically ranging from 30 GHz to 300 GHz) to detect and measure various physical properties and movements. Recently, mmWave sensing has been applied in various fields, such as automotive radar for advanced driver assistance systems (ADAS) and industrial automation for precise object detection and positioning, and other applications of mmWave sensing including sensing of people in some environments are being considered. In mmWave sensing, advanced signal processing techniques, such as Fast Fourier Transform (FFT) and Doppler processing, are employed to analyze signals reflected by objects from incident RF waves, enabling the detection of minute movements and providing detailed information about the environment. Because of the high frequency of the waves, mmWave offers high resolution, the ability to penetrate materials such as clothing and walls, and robustness against environmental conditions like lighting and weather. However, there are several challenges and problems with implementing detection systems that rely on mmWave sensing, including synchronization issues and data storage limitations that have not been addressed.

Embodiments of the present disclosure solve the challenges occurring with prior systems and provide further features and benefits that enable seamless implementation of improved monitoring systems.

Example embodiments disclosed herein can be implemented to provide improvements to a monitoring system that includes a hub in communication with simple and redundant sensors that aggregate activities in an enclosure, such as a building, that are sent to the hub. In such monitoring systems, the hub can be configured to then identify when those activities are occurring more or less often than expected and classifies the activity to piece together and learn the user's or individual's daily activity. Additional satellite devices may be added to the monitoring system hub that increase the range and capacity of sensors for collecting more information and activity within the building. In this manner, some monitoring systems use a redundant array of sensors to consistently monitor activities occurring in or around a building to create a trail and heatmap of events and activities that the monitoring system hub classifies, verifies with other sensors, learns, and then correctly processes. The example embodiments disclosed herein are suitable for providing improvements to these and other monitoring systems.

### Example Embodiments of a Monitoring System

FIG. 1 illustrates a network environment for implementing a monitoring system. As can be seen with reference to FIG. 1, the network environment 100 for implementing a monitoring system comprises various sensors and devices communicably coupled together.

Network environment 100 may include one or more networks such as an IoT network, a WiFi network, a Bluetooth network, a private network, the internet, any other network, or combinations thereof. The network environment 100 includes one or more satellite devices 160A, 160B, 160C . . . etc., (hereinafter referred to as 160). One or more of the satellite devices 160, such as satellite device 160C, may be configured to communicate (e.g., via wired or wireless communication) with one or more satellite devices 160B, one or more sensor devices 170B, and/or one or more hub devices 101. The network environment 100 includes one or more sensor devices 170A, 170B, 170C, 170D, 170E, 170F, 170G, 170H, 170I . . . etc., (hereinafter referred to as 170). One or more of the sensor devices 170, such as sensor device 170H, may be configured to communicate (e.g., via wired or wireless communication) with one or more satellite devices 160B and/or one or more hub devices 101. The network environment 100 includes one or more electronic devices 190A, 190B, 190C, 190D . . . etc., (hereinafter referred to as 190). One or more of the electronic devices 190, such as electronic device 190A, may be configured to communicate (e.g., via wired or wireless communication) with one or more satellite devices 160B and/or one or more hub devices 101. The network environment 100 includes one or more hub devices 101 in communication with one or more satellite devices 160 and one or more electronic device 190. Each hub device 101 may communicably couple to one or more servers within a cloud infrastructure 135.

The electronic devices 190 may include, may be embedded in, or may be coupled to a portable communication device, such as a mobile phone, a laptop, a wearable device, a tablet or any other communication device. The electronic devices 190 may be communicably coupled to one or more of the satellite devices 160, and/or to one or more other devices of the electronic devices 190. As depicted in FIG. 1 examples of electronic devices 190 may include a scale, a finger oximeter, a blood pressure monitoring device, a spirometer, a wearable device (e.g., watch, band, belt, etc. ,), a thermometer, an oxygen machine or mask (e.g., a nasal cannula oxygen machine), a camera, a computer, a desktop, a laptop, a tablet, a fax machine, a printer, light bulb, an appliance, and so forth.

Satellite devices 160 facilitate wireless communication between one or more hub devices 101, and one or more electronic devices 190 and sensor devices 170, and one or more servers within a cloud infrastructure 135. In some embodiments, satellite devices 160 may be on the same local area network as hub device 101. In some embodiments, satellite devices 160 may be configured to form a new local area network communicably coupled to hub device 101. The satellite devices 160 may communicatively couple one or more electronic devices 190 to one or more sensor devices 170, and vice versa. In one or more implementations, one or more of satellite devices 160 may be referred to as an IoT network and/or a machine-to-machine (M2M) network.

One or more of the sensor devices 170 may be referred to as an IoT device and/or an M2M device and may include human-machine interface (HMI) applications and machine-interface applications. The sensor devices 170 can be implemented as tags that can be attached to or carried by a person, or can be mounted on a wall or another surface. There may be multiple paths between one or more of the sensor devices 170 and/or one or more of the satellites 160. One or more of the satellites 160 and/or sensor devices 170 may be configured to communicate with one another or other systems and with one or more hub devices 101. One or more of the sensor devices 170 may include or may be a sensor that measures a physical quantity from surrounding environment and convert physical quantities into a signal. Examples of sensors include, by way of illustration only and not by way of limitation, temperature sensors, video cameras, audio recorders, motion sensors, humidity sensors, smoke detectors and other sensors. In some examples, the sensor devices 170 may all measure the same physical quantity from surrounding environment and convert physical quantities into a signal to provide redundancy/verify the measure physical quantity, for example, the sensor devices 170 may all measure motion and/or sound to confirm motion or sound occurred in a space.

One or more of the electronic devices 190 may be referred to as an IoT device and/or an M2M device and may include human-machine interface (HMI) applications and machine-interface applications. There may be multiple paths between one or more of the electronic devices 190 and/or one or more of the satellites 160. One or more of the satellites 160 and/or electronic devices 190 may be configured to communicate with one another or other systems and with one or more hub devices 101. One or more of the electronic devices 190 may include or may be a sensor that measures a physical quantity from surrounding environment and convert physical quantities into a signal. Examples of sensors include, by way of illustration only and not by way of limitation, temperature sensors, video cameras, audio recorders, motion sensors, humidity sensors, smoke detectors and other sensors. In some embodiments, the electronic devices 190 may all measure a similar physical quantity from surrounding environment and convert physical quantities into a signal to provide redundancy/verify the measure physical quantity, for example, the electronic devices 190 may all measure motion and/or sound to confirm motion or sound occurred in a space.

Electronic devices 190 may include one or more of active devices, passive devices and/or implemented wholly or partially as system on chip devices. Electronic devices 190 may include a transmitter, a receiver, a Global Positioning System (GPS), a Bluetooth (BT)/BLE transceiver and/or a WiFi™ transceiver. Similarly, sensor devices 170 may include one or more of active devices, passive devices and/or implemented wholly or partially as system on chip devices. Sensor devices 170 may include a transmitter, a receiver, a Global Positioning System (GPS), a Bluetooth (BT)/BLE transceiver and/or a WiFi™ transceiver. In one or more embodiments, satellite devices 160 may include and provide one or more network access points, such as a wireless access point (WAP), communicably coupling electronic devices 190 and/or sensor devices to one or more hub devices 101.

Detected or user inputted environmental information (e.g., temperature, humidity, sounds, pressure, air flow, air quality, pets, location of windows and doors, ambient light, outside weather, etc. ,) and individual information (age, posture, mobility, gait, height, weight, vitals, medication, physical address, medical conditions, physical activity requirements, etc. ,) may be classified in the hub device 101. The aggregated environmental and/or individual information (hereinafter “activity information”) is collected by the hub device 101 from sensor devices 170 and electronic devices 190, either directly from the hub device 101 or through one or more satellite devices 160. The collected activity information is then used by the hub device 101 to build a map of what happened, where it happened, and what sensors are involved. The hub device 101 then classifies each activity information from various sensor devices 170 and electronic devices 190 to determine the occurrence or non-occurrence of an event. For example, a caregiver may wish to monitor and ensure an individual with a medical condition (e.g., liver cirrhosis) is having adequate physical activity and urination/bowel movements. The hub device 101 may receive individual information from a caregiver/user input/remote computing device (e.g., the individual's medical condition, height, weight, vitals, etc. ,) and a request to monitor the individual for certain activities for managing or improving the medical condition. The caregiver may place electronic devices 190 and/or sensor devices 170 within a proximity of the hub device 101 to monitor the individual's progress. As an example, the individual may get out of bed to go to the bathroom, in doing so, sensor devices 170 and electronic devices 190 may detect the individual's motion and trajectory into the bathroom and subsequently detect only the sound of a faucet having occurred while the individual made a bathroom visit. The hub device 101 collects the activity information from sensor devices 170 and electronic devices 190 and may make multiple classifications, a first classification includes physical activity (e.g., a walking event) followed by turn of the faucet handle (e.g., arm movement/motion). However, additional activity information (subsequent activity) from sensor devices within or near the bathroom confirms that the shower or toilet was not used. Thus, a second classification is made that a non-occurrence of a bowel movement happened. The hub device 101 may continue to monitor the individual for the second classification, and if, the classification does not occur the hub device 101 may contact/inform a caregiver and/or remind the individual to either take medication to stimulate a bowel movement, perform additional walking events, or take meals or drinks to help with digestion, or any combination thereof. The hub device 101 may report the activities in textual format to the caregiver as a daily digest or journal of occurred and non-occurred individual events.

One or more sensor devices 170 and electronic devices 190 may further collect additional information, for example, the individual entering or leaving a room, standing, sitting, falling, various sound effects, sounds or movement of pets or animals. The sensor devices 170 and electronic devices 190 may store locally in a database or access remotely stored acoustic and/or video signatures used to indicate one or more events/activities occurring. In some embodiments, the hub device 101 may store locally in a database or access remotely stored acoustic and/or video signatures and compare/classify the activity with stored acoustic and/or video signatures. The hub device 101 may use collected activity information from individual sensors and devices to build the individuals habits, preferences, and progress in treating or managing the medical condition. The hub device 101 may be configured to collect only non-visual information from activity information may to protect the individual's privacy. The collected activity information may then be sent to caregivers by text message.

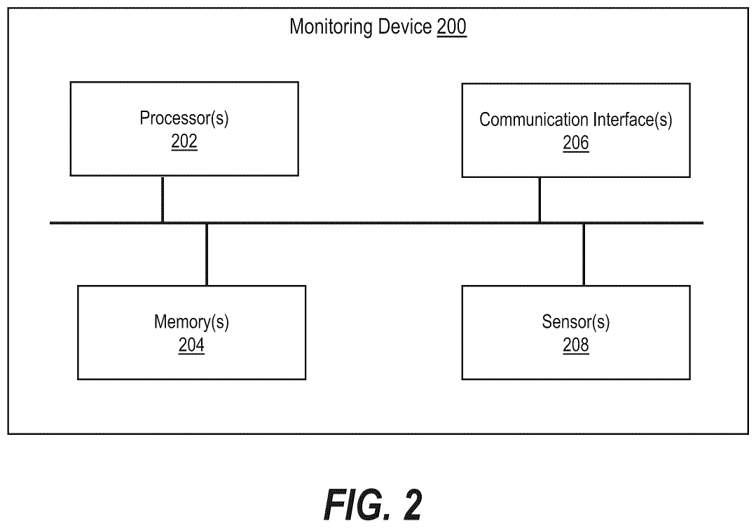

FIG. 2 provides a diagram illustrating an example of a monitoring device 200 that implements various embodiments described herein. The monitoring device 200 is a component of a monitoring system or network that is configured to monitor activity or non-activity in an environment or area based on collected sensor data. In some examples, the monitoring device 200 itself may collect the sensor data. In some examples, the monitoring device 200 may be one or more of a hub device, a satellite device, and/or a sensor device of the example monitoring system described with FIG. 1.

The monitoring device 200 includes at least one processor 202 and at least one memory 204 having instructions stored thereupon. The memory(s) 204 may store instructions to be executed by the processor(s) 202. The memory(s) 204 may be an electronic holding place or storage for information or instructions so that the information or instructions can be accessed by the processor(s) 202. The memory(s) 204 can include, but is not limited to, any type of random access memory (RAM), any type of read only memory (ROM), any type of flash memory, and/or the like, such as magnetic storage devices (e.g., hard disk, floppy disk, magnetic strips, etc.), optical disks (e.g., compact disk (CD), digital versatile discs (DVD), etc.), smart cards, flash memory devices, etc. The instructions upon execution by the processor 202 configure the monitoring device 200 to perform the example operations and techniques described herein.

The instructions executed by the processor(s) 202 may be carried out by a special purpose computer, logic circuits, or hardware circuits. The processor(s) 202 may be implemented in hardware, firmware, software, or any combination thereof. The term “execution” is, for example, the process of running an application or the carrying out of the operation called for by an instruction. The instructions may be written using one or more programming language, scripting language, assembly language, etc. By executing the instructions, the processor(s) 202 can perform the operations called for by that instruction. The processor(s) 202 operably couples with the memory(s) 204 and network interface(s) 206 to receive, to send, and to process information and to control the operations of the monitoring device 200. The processor(s) 202 may retrieve a set of instructions from a permanent memory device such as a ROM device and copy the instructions in an executable form to a temporary memory device that is generally some form of RAM. In some implementations, the monitoring device 200 can include a plurality of processors that use the same or a different processing technology.

The network interfaces 206 transmit and receive information or data to another computing system or device, such as another monitoring device, a remote server or system, a user device, and/or the like. The network interfaces 206 can include one or more transmitters, receivers, transceivers, and/or the like.

Example Embodiments for mmWave Sensing in a Monitoring System

As described herein, various sensing modalities can be implemented by monitoring devices of an example monitoring system in order to classify new activities, normally occurring activities, and/or the like. According to example embodiments, an example monitoring device (e.g., a hub device, a satellite device, a sensor device of the example monitoring system of FIG. 1) can further implement millimeter-wave (mmWave) sensing components as an additional or alternative sensing modality. For example, a sensor device of an example monitoring system implements a mmWave sensing chip, such as the Texas Instruments IWR6843 device, configured to transmit mmWave signals and process received signal reflections to generate mmWave sensor data such as point clouds. In an example embodiment, a sensor device of a monitoring system implements a mmWave transceiver (e.g., the IWR6843 chip) and collects individual and environmental activity via mmWave sensor data in addition to audio, visual, and other data.

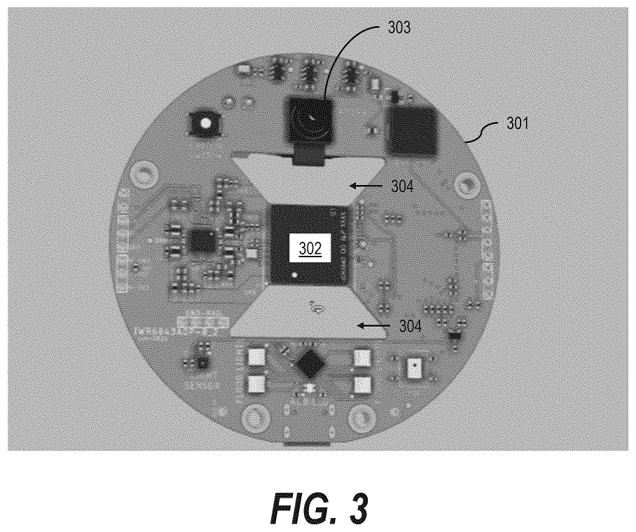

FIG. 3 depicts a view of internal portions of an example monitoring device of a monitoring system. The monitoring device may be a hub device, a satellite device, and/or a sensor device, or a part thereof. The monitoring device comprises a circuit board 301 on which various processing and electronic components of the monitoring device are mounted, including a mmWave transceiver 302 that can be used for mmWave sensing. For example, the monitoring device is deployed in a sensing area and is configured to use mmWave transmission and sensing (as at least one modality) to collect activity data within the sensing area. The monitoring device may be configured for additional or alternative sensing modalities; for example, the illustrated example includes a red-green-blue (RGB) camera 303 (e.g., Omnivision OG02B10) mounted on the circuit board 301 for collecting visual data. In some embodiments, the mmWave transceiver 302 (hereinafter sometimes referred to as the sensing device) may be centered on the circuit board 301.

Different modalities of activity data (e.g., visual and mmWave) may be collected, and in order for those different modalities to be effectively used in combination with one another, it is helpful for those different modalities of activity data to be collected from a similar or the same relative point-of-view. Otherwise, for example, there may be challenges with registering, fusing, combining, or the like mmWave data captured from a mmWave sensing device and visual data captured from a camera that is not sufficiently co-located with the mmWave transceiver. However, there may be requirements and limitations that constrain the placement of devices on a circuit board.

In some embodiments, the monitoring device of the monitoring system includes air gaps 304 located adjacent to the mmWave transceiver 302. The air gaps 304 can satisfy the mounting requirements associated with the mmWave transceiver 302 based at least on their shape or size. Further, the camera 303 is mounted adjacent to at least one of the air gaps 304, thus minimizing the distance between the camera 303 and the mmWave transceiver 302 while continuing to satisfy the operating requirements associated with the mmWave transceiver 302.

Time Synchronization for mmWave Sensors

Since mmWave devices like the IWR6843 employ a conical view frustum where activity is able to be sensed, there are inherent blind spots in the coverage within a room. Also, the nature of the problem is to detect activities in rooms that are often full of objects like furniture, which may occlude the sensor depending on the orientation of the furniture and the placement of the sensor. In these scenarios, it would be helpful to have multiple sensors in a single room. However, when using multiple mmWave sensors, the RF beams may overlap, resulting in the sensors interfering with one another. Existing solutions rely upon connecting a ‘sync’ cable between devices so that their clocks are synchronized and/or by switching frequency bands. However, this can add additional physical obstructions in a home.

Example embodiments address these challenges based on assigning time slices/frames to different mmWave devices in an area. For example, first, all of the available frames are dedicated to a master device. When collisions are detected arising from multiple mmWave sensors with overlapping RF beams, frames are allocated in a way to allow additional sensors to co-exist in the same room by allocating separate frames to each device. These collisions between mmWave transmissions (e.g., radar-radar interference) can be detected as small glitches returned out of an analog-to-digital converter (ADC) of each mmWave transceiver. When allocating frames to each device, the “chirp” frequency of outgoing radar signals can be slightly reduced, to allow a wider selection of time-frames with which multiple radar systems can operate. In some embodiments, the time slices are arbitrarily assigned using a controlling hub or master device.

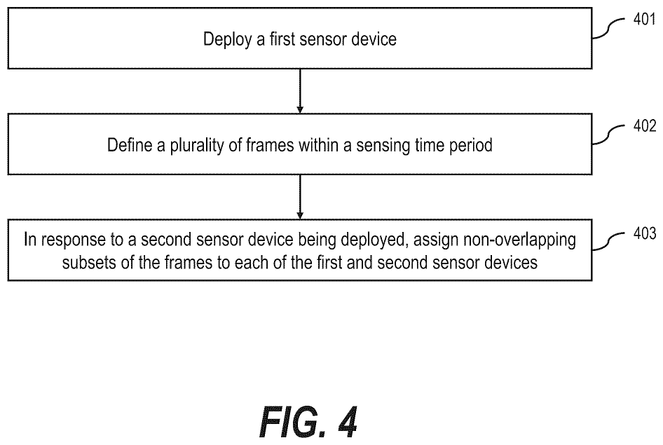

FIG. 4 is a flow chart illustrating an exemplary method of implementing mmWave sensing for multiple sensor devices of an example monitoring system. Each box shown in FIG. 4 may represent one or more processes, methods or subroutines, carried out in the exemplary method. Further for explanatory purposes, the boxes of the illustrated process are described herein as occurring in serial, or linearly. However, multiple boxes of the illustrated process may occur in parallel. In addition, the boxes of the illustrated process may be performed in a different order than the order shown and/or one or more of the boxes of the illustrated may not be performed.

The exemplary method of FIG. 4 includes deploying a first mmWave sensing device (box 401). The first mmWave sensing device can be a monitoring device (e.g., a hub device, a satellite device, a sensor device) or a part thereof, and the first mmWave sensing device is configured to transmit mmWave signals and process reflected signals to generate mmWave sensing data (e.g., a point cloud of objects in a sensing area). The method further includes defining a plurality of frames within a sensing time period (box 402). While only the first sensor device is deployed, the plurality of frames may be assigned to the first sensor device. In some examples, a single chirp by a mmWave transceiver takes on the order of microseconds, and the time frames can be defined to each comprise multiple chirps. In an example, a frame spacing of 10 Hz is used; this may downgrade fidelity but remains effective for at least the detection of object presence.

In some scenarios, a second mmWave sensing device may be deployed for sensing during the sensing time period. The second mmWave sensing device may be oriented such that its sensing transmissions intersect with those of the first sensor device. To avoid or minimize interference between the first and second mmWave sensing devices, the method further includes, in response to the second sensor device being deployed, assigning non-overlapping subsets of frames to the first sensor device and the second sensor device (box 403). In some embodiments, the assignment of frames may be determined by a different monitoring device of the monitoring system, such as a satellite device or a hub device. This different device may transmit the frame assignments to the first and second sensor devices. In some examples, the determination of the non-overlapping frame subsets may be random, based on relative locations of the first and second sensor devices, based on the expected activity in the area, and/or the like. For example, an equal number of frames may be assigned to the first sensor device and the second sensor device, or one of the first and second sensor devices may be assigned with more frames.

Effective detection of objects via mmWave sensing may require a lower duration and/or frequency of mmWave signal transmissions compared to precise mapping of object features via mmWave sensing. In some embodiments, an average or approximate size of target objects for mmWave sensing is identified (e.g., the size of a human, the size of a pet), and the frames may be defined within the sensing time period such that a frame pattern assigned to a device (e.g., every other frame, every other N frames) satisfies a minimum duration/frequency of mmWave signal transmission for the device to effectively detect objects.

Positioning Apparatus for mmWave Sensing Devices

To provide meaningful and effective use, a mmWave sensing device of the monitoring system typically has to be mounted high in a room and at a fixed and specific downward angle. This would allow the mmWave sensing device to capture the relevant activity (or non-activity) within the room for classification. For example, the device may need to be positioned at 7 feet high (and at a 15-degree downward angle, in some instances) in order to scan above the height of persons in a monitoring area and avoid occlusion from multiple people in the same space. Furthermore, mmWave sensing devices draw significant amounts of power, typically precluding operation on battery power. At least in the context of home monitoring use, these requirements present challenges for consumers and users to effectively use mmWave sensing components of their monitoring systems.

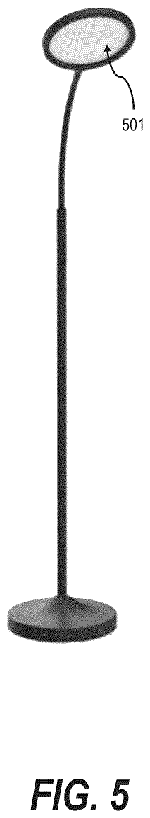

To address these challenges, example embodiments include a mounting platform for a mmWave sensing device of a monitoring system. The mounting platform resembles and can be effectively used as a floor lamp, thus providing suitable and aesthetic use within a home, for example. FIG. 5 illustrates an example of a mounting platform resembling a floor lamp. The head of the mounting platform holds an LED light ring, in the center of which is the mmWave sensing device 501. This embodiment is unobtrusive in a consumer's home and comprises a hidden cord in the stem of the lamp to supply power to the mmWave sensing device. The mounting platform maintains the mmWave sensing device at a fixed height and downward angle. In some embodiments, an opening of the mounting platform (e.g., the head of the “lamp”) through which the mmWave sensing device is oriented includes a translucent or opaque cover, so that the mmWave sensing device is not immediately visible to a user (thus providing a sense of privacy).

### Light-based Indications From Sensing

Millions of homes have simple motion-activated nightlights. Most often, these devices incorporate a simple passive infrared (PIR) sensor that is able to detect the movement of a warm body. This detected motion triggers a light to be turned on for a period of time. However, these night lights are limited to a single method of illumination and usually a single method of motion detection.

According to example embodiments, more dynamic, informative, and effective lighting can be provided based on the enhanced sensing and monitoring (e.g., via mmWave sensing) provided by example monitoring systems. In example embodiments, a monitoring device of a monitoring system (e.g., a hub device, satellite device, or sensor device of the example monitoring system of FIG. 1) includes a plurality of lights (e.g., light-emitting diodes (LEDs)) via which the monitoring device can provide a light pattern in response to detecting certain activities or non-activities. In some embodiments, the plurality of lights of a monitoring device are oriented in a geometry, such as a ring, and a light pattern provided in response to a detected activity or non-activity can include a spatial pattern (in addition to or alternative to temporal patterns like flashing or a static light). In an example, the monitoring device is attached to or within a floor lamp mounting platform, and the plurality of lights are user-operable for floor lamp operation, separate from providing the light patterns.

The light patterns provided by a monitoring device can be provided for positive feedback, assistance, mitigation, and/or the like for different activities including normally occurring activities. For example, upon detecting that a pediatric patient is stirring but has not woken up, the monitoring device is configured to provide a light pattern that includes a static low-brightness violet hue that is configured to have a calming effect for the pediatric patient. In another example, upon detecting that a specific individual (e.g., specifically identified according to various techniques disclosed further herein) has entered a room, the monitoring device is configured to provide a light pattern that illuminates the room for the specific individual. In yet another example, if a fall has been detected, the monitoring device is configured to fully illuminate the room and blink a red hue to indicate an emergency. In yet another example, the monitoring device is configured to provide a low amber light to illuminate a room at night to avoid night-blindness. Additionally, particular indications (e.g., poke animations or notifications) that are received by a master device (e.g., a satellite device, a hub device) can be rendered as a light pattern by the monitoring device.

### Onboard Classifier Solutions

As discussed herein, different modalities of sensor data—including audio, visual, and mmWave sensor data—can be used to collect activity (or non-activity) in an area. According to example embodiments, machine learning techniques can be implemented to classify the activity (or non-activity) captured within the collected sensor data.

In some embodiments, classification of activities or non-activities within sensor data may be performed within the monitoring system, and use of a remote platform or system for machine learning (ML) inference may be avoided or minimized. With the widespread adoption of machine learning approaches to problem solving, a new generation of computing device has emerged called a tensor processing unit (TPU). These devices are specifically designed to process billions or even trillions of matrix calculations per second using smaller math processing units than would be required in a graphical processing unit (GPU). However, these chips are still prohibitively expensive for inexpensive consumer electronics. On the other hand, inexpensive systems-on-a-chip (SOCs) or microcontroller units (MCUs), such as SOCs for mmWave sensing (e.g., the IWR6843 device) that are more feasible for implementing components devices of a monitoring system (e.g., a hub device, a satellite device, a sensor device) are unable to hold very many tensors at a time, thus limiting how robust and accurate a ML solution can be.

Further yet, example embodiments of a monitoring system are configured to incorporate a plurality of different classifiers that are generated and trained for extracting different types of activities. As an example, a monitoring system as disclosed herein may use a first classifier that is specifically trained for classifying activities or non-activities relevant for an elderly person under care (e.g., getting out of bed, walking to the kitchen), but may use a second classifier that is specifically trained for classifying activities or non-activities relevant for pediatric care (e.g., vital signs, crying, movement in bed/crib). The need for multiple different classifiers for different monitoring contexts or uses extenuates the challenges with implementing onboard ML solutions discussed above.

To address these challenges, example embodiments implement an additional microcontroller unit (MCU) or processing device as a management integrated circuit (IC). In one example, a monitoring device of the monitoring system implements an Espressif ESP32-S3 MCU. The additional MCU included in the monitoring device of the monitoring system (which may also implement a mmWave sensing device) can be configured to handle tasks such as firmware over-the-air (OTA) services, local network management, and watchdog functions. More particularly, the additional MCU can be used to cache a collection of ML classifiers that were generated externally using large arrays of TPUs. These ML classifiers are collected into packages or notebooks (each having one or more classifiers) based on common use-case or context (e.g., pediatric monitoring, fall detection) and stored in the additional MCU (e.g., the ESP32-S3).

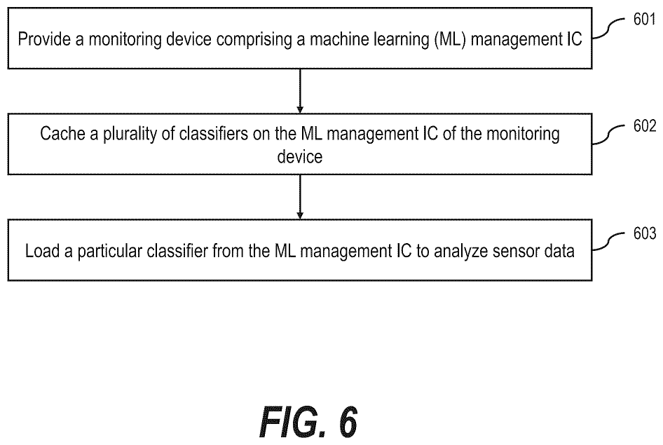

FIG. 6 is a flow chart illustrating an exemplary method of implementing mmWave sensing for multiple sensor devices of an example monitoring system. Each box shown in FIG. 6 may represent one or more processes, methods or subroutines, carried out in the exemplary method. Further for explanatory purposes, the boxes of the illustrated process are described herein as occurring in serial, or linearly. However, multiple boxes of the illustrated process may occur in parallel. In addition, the boxes of the illustrated process may be performed in a different order than the order shown and/or one or more of the boxes of the illustrated may not be performed.

The exemplary method of FIG. 6 includes providing a monitoring device comprising a machine learning (ML) management integrated circuit (IC) or device (box 601). The ML management IC is configured to cache a plurality of classifiers each specialized for a respective activity or object type and load a classifier for processing collected sensor data. In some embodiments, the monitoring device is a hub device or a satellite device and includes the ML management IC in order to process (by loading a particular classifier) sensor data received from connected sensor devices. In some embodiments, the monitoring device is a sensor device and includes the ML management IC in order to process (by loading a particular classifier) sensor data that it collects (e.g., mmWave point cloud data collected by an onboard IWR6843 device).

The method further includes storing or caching a plurality of classifiers onto the ML management IC (box 602). The plurality of classifiers may be received at the monitoring device from a remote computing system where the classifiers are generated, defined, tuned, trained, and/or the like. Each classifier may be loaded and stored in the form of tensors or matrices that define parameters or weights throughout a model structure. For example, each classifier is defined as a neural network model with trained weight parameters for each node of each layer of the neural network model.

The method further includes loading, in response to an input, one or more particular classifiers stored by the ML management IC (box 603). The one or more particular classifiers may be loaded in order to process or analyze sensor data received (and/or collected) by the monitoring device for a particular use-case or context. In order to load a package of the one or more particular classifiers, the one or more classifiers can be loaded from their cache or storage location onto the mmWave transceiver device (e.g., the IWR6843 device) and/or the ML management IC (e.g., the ESP32-S3 device) depending on the complexity of the operation and the particular use-case/context.

The particular classifier to be loaded may be identified based on the input. In particular, the input may identify the expected or normal activity in a sensing area (e.g., monitoring for an elderly person, monitoring for a pediatric patient, monitoring for a pet, monitoring customers in a retail store), and the particular classifier may be a model trained specifically for classifying such activities or contexts. For example, the input may be provided via a hub device and/or a user device in communication with the monitoring system to indicate that the monitoring device is changing activity contexts from a home's nursery (to monitor a baby) to the home's guest room (to monitor an elderly person). In another example, the input is associated with an initial setup or deployment process for the monitoring device; the monitoring device may be pre-configured (and/or updated) with the plurality of classifiers, and the user's setup of the monitoring device can indicate an activity context according to which the particular classifier can be determined and loaded.

Sensor Fusion Incorporating 3D mmWave Data

Example embodiments herein leverage mmWave sensing and/or three-dimensional (3D) sensing with other sensing modalities in order to improve classifier inputs (akin to sensor fusion), improve and accelerate classifier generation and training, and improve unique identification of individuals in a monitoring/sensing area.

In classifier training, it is often difficult to perform automated image identification of 2D images. Various factors such as lighting, shadows, or environmental particles such as smoke obscuring the captured 2D image making identification difficult. Modern cameras designed for this problem often integrate depth-sensing technology like LIDAR, however these cameras are prohibitively expensive for consumer electronics devices. Using neural network classifiers in image and audio analysis also introduces challenges, especially in human activity contexts. The first challenge is that thousands of recorded samples are required for the creation of NN classifiers. Second, even when there is sufficient image or audio data that is provided for the creation of the classifiers, there is insufficient information for efficient feature extraction (e.g., due to noise, artifacts, obstructions in a 2D image).

According to example embodiments, three-dimensional data captured via mmWave sensing can be combined or fused with other data, including two-dimensional (2D) visual data and audio data. Doing so can improve the classifier inference (with the enhanced or fused data enabling improved edge/object detection) and can enable or improve automation of training data labeling.

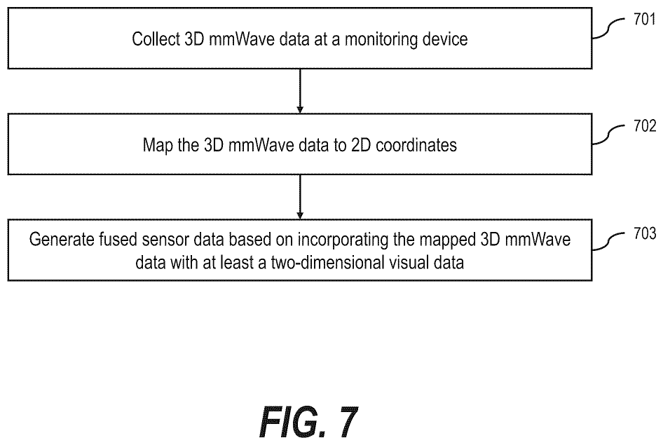

FIG. 7 is a flow chart illustrating an exemplary method of using mmWave sensing data collected by an example monitoring system. Each box shown in FIG. 7 may represent one or more processes, methods or subroutines, carried out in the exemplary method. Further for explanatory purposes, the boxes of the illustrated process are described herein as occurring in serial, or linearly. However, multiple boxes of the illustrated process may occur in parallel. In addition, the boxes of the illustrated process may be performed in a different order than the order shown and/or one or more of the boxes of the illustrated may not be performed.

The exemplary method of FIG. 7 includes collecting three-dimensional mmWave data at a monitoring device (box 701). The monitoring device can be any of a hub device, satellite device, or sensor device of a monitoring system and includes a mmWave sensing device (e.g., an IWR6843 device). The three-dimensional mmWave data may be collected concurrently with other data, including audio data and two-dimensional visual data collected by a camera included in the monitoring device (or any other monitoring devices). In one example, the two-dimensional visual data is RGB data with values for color components. The three-dimensional mmWave data may be extracted from a data stream from the mmWave sensing device (e.g., to a main processor of the monitoring device).

The method further includes mapping the three-dimensional mmWave data to two-dimensional coordinates (box 702). In some embodiments, the mapping is performed via a rasterization technique. In particular, the three-dimensional mmWave data is mapped to two-dimensional coordinates corresponding to those associated with the two-dimensional visual data concurrently collected by the monitoring system. In some embodiments, mapping the three-dimensional mmWave data to two-dimensional coordinates associated with the two-dimensional visual data includes normalizing different fields-of-view (FOVs) used by the different sensing components. For example, the mmWave sensing device may have a 140-degree FOV while the camera has a 120-degree FOV, and one of the mmWave data and the visual data is transformed, clipped, and/or the like to match the FOV of the other. By performing the mapping, the three-dimensional mmWave data can be transformed to a two-dimensional depth map that aligns with the two-dimensional visual data.

The method further includes generating fused sensor data based on incorporating the mapped three-dimensional mmWave data with at least the two-dimensional visual data (box 703). Based at least on the mmWave depth map aligning with the two-dimensional visual data, the mmWave depth map can be incorporated or combined with the two-dimensional visual data as a data component, such as an alpha channel. Thus, for example, the two-dimensional visual data can be enhanced into a three-dimensional image using the mmWave sensing data.

As identified above, the fusion between two-dimensional visual data and three-dimensional mmWave data can be used at least for classifier inference (e.g., the classifier can be configured to receive the fused sensor data as input) and automated data labeling. In some embodiments, additional data can be incorporated with the fused sensor data when providing data to a classifier for analysis. For example, the fused sensor data can be further fused or combined with audio data.

Separately, training data labeling can be improved based on the incorporation of mmWave sensing data with other sensor data. In particular, the fused sensor data generated according to the method of FIG. 7 can be used in an automated process of labeling and tagging data for training multiple different classifiers. The incorporation of three-dimensional depth information in the fused sensor data improves automated labeling or tagging of activities including sitting, standing, walking, falling, laying, sneezing, coughing, choking, and sudden infant death syndrome (SIDS). For instance, with the three-dimensional depth information, left-side laying can be distinguished from right-side laying with improved accuracy. Furthermore, in both inference and training contexts, the incorporation of the three-dimensional depth information improves the unique identification of individuals. While specific identification of individuals can be limited in 2D imaging, the fused sensor data includes an additional dimension by which an individual can be specifically identified and distinguished from others. This unique identification of individuals again enables improved classifier inference (e.g., identifying activities and non-activities) and classifier training (e.g., faster and more efficient training data labeling).

Those of skill will appreciate that the various illustrative logical blocks, configurations, modules, circuits, and algorithm steps described in connection with the embodiments disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

The following technical solutions may be implemented by some preferred embodiments.

Solution 1. A monitoring system, comprising: a plurality of sensor devices each configured to collect sensor data from a respective environment, the plurality of sensor devices being spread across multiple locations within an area; and a hub device in communication with the plurality of sensor devices and configured to detect abnormal activity in the area based on the sensor data collected by the plurality of sensor devices, wherein the sensor data includes one or more three-dimensional point clouds generated by respective millimeter-wave (mmWave) sensing components implemented by at least a first sensor device and a second sensor device of the plurality of sensor devices, wherein the first sensor device and the second sensor device are assigned with non-overlapping sets of time frames during which mmWave signal transmissions are permitted.

Solution 2. The monitoring system of solution 1, wherein the first sensor device and the second sensor device have respective orientations that intersect with one another.

Solution 3. The monitoring system of any of solutions 1-2, wherein the non-overlapping sets of time frames are determined and assigned by the hub device in response to detecting that a later-deployed one of the first sensor device and the second sensor device has interfered with an earlier-deployed one of the first sensor device and the second sensor device.

Solution 4. A monitoring system, comprising: a plurality of sensor devices each configured to collect sensor data from a respective environment, the plurality of sensor devices being spread across multiple locations within an area, wherein at least one of the sensor device implements a mmWave transceiver for generating mmWave sensor data; and a hub device in communication with the plurality of sensor devices and configured to detect abnormal activity in the area based on the sensor data collected by the plurality of sensor devices.

Solution 5. The monitoring system of solution 4, wherein the hub device comprises: at least one processor configured to execute instructions stored in at least one memory to detect the abnormal activity based on the sensor data; and a controller unit communicably coupled to the at least one processor and configured to store a plurality of classifiers trained for a plurality of activity contexts and to load, for the at least one processor, a particular classifier for analyzing the sensor data.

Solution 6. The monitoring system of any of solutions 4-5, wherein at least one of the hub device or the at least one sensor device implementing the mmWave transceiver is configured to: obtain two-dimensional visual data collected concurrently with the three-dimensional point cloud; map the three-dimensional point cloud to two-dimensional coordinates associated with the two-dimensional visual data; and generate fused sensor data that incorporates the mapped three-dimensional point cloud with the two-dimensional visual data.

Solution 7. The monitoring system of any of solutions 4-6, wherein the two-dimensional visual data is collected via a camera component implemented by the at least one sensor device, and wherein the camera component is positioned within the at least one sensor device across from an air gap adjacent to the mmWave sensing component.

Solution 8. A monitoring system, comprising: a plurality of sensor devices each configured to collect sensor data from a monitoring environment, the plurality of sensor devices being positioned at multiple locations within the monitoring environment and each comprising a millimeter-wave (mmWave) sensing component; and a hub device in communication with the plurality of sensor devices and configured to detect abnormal activity in the monitoring environment based on the sensor data collected by the plurality of sensor devices, wherein the hub device is configured to: obtain a pre-trained machine learning (ML) classifier for a monitoring time period via an over-the-air (OTA) message, wherein the pre-trained ML classifier is implemented by the hub device for analyzing the sensor data collected by the plurality of sensor devices from the monitoring environment, assign non-overlapping sets of time frames within the monitoring period to each of the plurality of sensor devices, each sensor device being permitted to transmit mmWave sensing signals from the mmWave sensing component only during the time frames in a respectively assigned set, and detect the abnormal activity by detecting non-occurrence of an expected activity by an individual within the monitoring environment based on analyzing the sensor data collected by the plurality of sensor devices during the monitoring time period using the pre-trained ML classifier.

Solution 9. The monitoring system of solution 8, wherein the plurality of sensor devices are oriented such that at least two of the sensor devices have intersecting fields-of-view for their respective mmWave sensing components.

Solution 10. The monitoring system of any of solutions 8-9, wherein the hub device is configured to assign the non-overlapping sets of time frames in response to detecting that the mmWave sensing signals transmitted by a first sensor device have interfered with the mmWave sensing signals transmitted by a second sensor device.

Solution 11. The monitoring system of any of solutions 8-10, wherein a frame duration and a number of time frames per set are determined based on an estimated size of one or more individuals to be monitored within the monitoring environment.

Solution 12. The monitoring system of any of solutions 8-11, wherein a frame duration and a number of time frames per set are determined based on an estimated size of body features needed to specifically identify a set of individuals to be monitored within the monitoring environment.

Solution 13. The monitoring system of any of solutions 8-12, wherein each sensor device further comprises a camera component, and wherein the sensor data comprises fusion data in which mmWave sensor data and camera data collected by a given sensor device are registered with one another.

Solution 14. The monitoring system of solution 13, wherein each sensor device comprises a board on which the mmWave sensing component and the camera component are mounted, wherein the camera component is located across an air gap in the board from the mmWave sensing component.

Solution 15. The monitoring system of any of solutions 8-14, wherein analyzing the sensor data comprises identifying a presence of the individual from a set of individuals to be monitored within the monitoring environment.

Solution 16. The monitoring system of any of solutions 8-15, wherein the pre-trained ML classifier is pre-trained for analyzing behaviors in the monitoring environment specifically with respect to the individual.

Solution 17. The monitoring system of any of solutions 8-16, wherein the pre-trained ML classifier is implemented by each sensor device based on being stored by an additional microcontroller unit.

Solution 18. The monitoring system of any of solutions 8-17, wherein at least one sensor device is mounted in a floor lamp platform that positions the at least one sensor device above a seven-foot level and orients the at least one sensor device downwards.

Solution 19. The monitoring system of any of solutions 8-18, wherein the floor lamp platform comprises an opaque cover that hides the at least one sensor device from view.

Solution 20. A method for monitoring abnormal activities using a plurality of monitoring devices positioned within a monitoring environment, comprising: obtaining, by at least one of the plurality of monitoring devices, a pre-trained ML classifier for a monitoring time period via an OTA message, wherein the pre-trained ML classifier is associated with a particular activity context for analyzing sensor data collected by the plurality of monitoring devices; assigning respective sets of time frames within the monitoring time period to each of a subset of monitoring devices comprising mmWave sensing components, the subset of monitoring devices being permitted to transmit mmWave sensing signals from the mmWave sensing components only during the time frames in the respective sets; and detecting an abnormal activity by detecting non-occurrence of an expected activity by an individual within the monitoring environment based on analyzing the sensor data collected by the plurality of monitoring devices during the monitoring time period using the pre-trained ML classifier.

Solution 21. The method of solution 20, wherein the subset of monitoring devices are oriented such that at least two of the subset of monitoring devices have intersecting fields-of-view for their respective mmWave sensing components.

Solution 22. The method of any of solutions 20-21, comprising assigning the respective sets of time frames in response to detecting that the mmWave sensing signals transmitted by a first monitoring device have interfered with the mmWave sensing signals transmitted by a second monitoring device.

Solution 23. The method of any of solutions 20-22, comprising determining a frame duration and a number of time frames per set based on an estimated size of a set of individuals to be monitored within the monitoring environment or an estimated size of body features needed to specifically identify the set of individuals.

Solution 24. The method of any of solutions 20-23, wherein each of the subset of monitoring devices further comprises a camera component, and wherein the sensor data comprises fusion data in which mmWave sensor data and camera data collected by a given monitoring device are registered with one another.

Solution 25. The method of solution 24, wherein each of the subset of monitoring devices comprises a board on which the mmWave sensing component and the camera component are mounted, wherein the camera component is located across an air gap in the board from the mmWave sensing component

Solution 26. The method of any of solutions 20-25, wherein the particular activity context associated with the pre-trained ML classifier is a presence of a particular individual from a set of individuals to be monitored within the monitoring environment.

Solution 27. The method of any of solutions 20-26, wherein at least one monitoring device is mounted in a floor lamp platform that positions the at least one sensor device above a seven-foot level and orients the at least one sensor device downwards.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor, and the storage medium may reside as discrete components in a computing device or user terminal.

Further, specific details are given in the description to provide a thorough understanding of the embodiments. However, embodiments may be practiced without these specific details. For example, well-known circuits, processes, algorithms, structures, and techniques have been shown without unnecessary detail to avoid obscuring the embodiments. This description provides example embodiments only and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Where applicable, various embodiments provided by the present disclosure may be implemented using hardware, software, or combinations of hardware and software. In addition, where applicable, the various hardware components and/or software components, set forth herein, may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software or application, in accordance with the present disclosure, such as program code and/or data, may be stored on one or more computer-readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

It should be noted that the methods described above describe possible implementations, and that the operations and the steps may be rearranged or otherwise modified and that other implementations are possible. Furthermore, embodiments from two or more of the methods may be combined.

From the foregoing, it will be appreciated that specific embodiments of the present disclosure have been described herein for purposes of illustration, but that various modifications may be made without deviating from the scope of the present disclosure. Rather, in the foregoing description, numerous specific details are discussed to provide a thorough and enabling description for embodiments of the present disclosure. One skilled in the relevant art, however, will recognize that the disclosure can be practiced without one or more of the specific details. In other instances, well-known structures or operations often associated with memory systems and devices are not shown, or are not described in detail, to avoid obscuring other aspects of the present disclosure. In general, it should be understood that various other devices, systems, and methods in addition to those specific embodiments disclosed herein may be within the scope of the present disclosure.

1. A monitoring system, comprising:
a plurality of sensor devices each configured to collect sensor data from a monitoring environment, the plurality of sensor devices being positioned at multiple locations within the monitoring environment and each comprising a millimeter-wave (mmWave) sensing component; and
a hub device in communication with the plurality of sensor devices and configured to detect abnormal activity in the monitoring environment based on the sensor data collected by the plurality of sensor devices, wherein the hub device is configured to:
obtain a pre-trained machine learning (ML) classifier for a monitoring time period via an over-the-air (OTA) message, wherein the pre-trained ML classifier is implemented by the hub device for analyzing the sensor data collected by the plurality of sensor devices from the monitoring environment,
assign non-overlapping sets of time frames within the monitoring period to each of the plurality of sensor devices, each sensor device being permitted to transmit mmWave sensing signals from the mmWave sensing component only during the time frames in a respectively assigned set, and
detect the abnormal activity by detecting non-occurrence of an expected activity by an individual within the monitoring environment based on analyzing the sensor data collected by the plurality of sensor devices during the monitoring time period using the pre-trained ML classifier.

2. The monitoring system of claim 1, wherein the plurality of sensor devices are oriented such that at least two of the sensor devices have intersecting fields-of-view for their respective mmWave sensing components.

3. The monitoring system of claim 1, wherein the hub device is configured to assign the non-overlapping sets of time frames in response to detecting that the mmWave sensing signals transmitted by a first sensor device have interfered with the mmWave sensing signals transmitted by a second sensor device.

4. The monitoring system of claim 1, wherein a frame duration and a number of time frames per set are determined based on an estimated size of one or more individuals to be monitored within the monitoring environment.

5. The monitoring system of claim 1, wherein a frame duration and a number of time frames per set are determined based on an estimated size of body features needed to specifically identify a set of individuals to be monitored within the monitoring environment.

6. The monitoring system of claim 1, wherein each sensor device further comprises a camera component, and wherein the sensor data comprises fusion data in which mmWave sensor data and camera data collected by a given sensor device are registered with one another.

7. The monitoring system of claim 6, wherein each sensor device comprises a board on which the mmWave sensing component and the camera component are mounted, wherein the camera component is located across an air gap in the board from the mmWave sensing component.

8. The monitoring system of claim 1, wherein analyzing the sensor data comprises identifying a presence of the individual from a set of individuals to be monitored within the monitoring environment.

9. The monitoring system of claim 1, wherein the pre-trained ML classifier is pre-trained for analyzing behaviors in the monitoring environment specifically with respect to the individual.

10. The monitoring system of claim 1, wherein the pre-trained ML classifier is implemented by each sensor device based on being stored by an additional microcontroller unit.

11. The monitoring system of claim 1, wherein at least one sensor device is mounted in a floor lamp platform that positions the at least one sensor device above a seven-foot level and orients the at least one sensor device downwards.

12. The monitoring system of claim 1, wherein the floor lamp platform comprises an opaque cover that hides the at least one sensor device from view.

13. A method for monitoring abnormal activities using a plurality of monitoring devices positioned within a monitoring environment, comprising:
obtaining, by at least one of the plurality of monitoring devices, a pre-trained ML classifier for a monitoring time period via an over-the-air (OTA) message, wherein the pre-trained ML classifier is associated with a particular activity context for analyzing sensor data collected by the plurality of monitoring devices;
assigning respective sets of time frames within the monitoring time period to each of a subset of monitoring devices comprising mmWave sensing components, the subset of monitoring devices being permitted to transmit mmWave sensing signals from the mmWave sensing components only during the time frames in the respective sets; and
detecting an abnormal activity by detecting non-occurrence of an expected activity by an individual within the monitoring environment based on analyzing the sensor data collected by the plurality of monitoring devices during the monitoring time period using the pre-trained ML classifier.

14. The method of claim 13, wherein the subset of monitoring devices are oriented such that at least two of the subset of monitoring devices have intersecting fields-of-view for their respective mmWave sensing components.

15. The method of claim 13, comprising assigning the respective sets of time frames in response to detecting that the mmWave sensing signals transmitted by a first monitoring device have interfered with the mmWave sensing signals transmitted by a second monitoring device.

16. The method of claim 13, comprising determining a frame duration and a number of time frames per set based on an estimated size of a set of individuals to be monitored within the monitoring environment or an estimated size of body features needed to specifically identify the set of individuals.

17. The method of claim 13, wherein each of the subset of monitoring devices further comprises a camera component, and wherein the sensor data comprises fusion data in which mmWave sensor data and camera data collected by a given monitoring device are registered with one another.

18. The method of claim 17, wherein each of the subset of monitoring devices comprises a board on which the mmWave sensing component and the camera component are mounted, wherein the camera component is located across an air gap in the board from the mmWave sensing component 19. The method of claim 13, wherein the particular activity context associated with the pre-trained ML classifier is a presence of a particular individual from a set of individuals to be monitored within the monitoring environment.

20. The method of claim 13, wherein at least one monitoring device is mounted in a floor lamp platform that positions the at least one sensor device above a seven-foot level and orients the at least one sensor device downwards.
